(19) United States
(12) Patent Application Publication
(10) Pub. No.: US 2019/0385561 A1
(43) Pub. Date: Dec. 19, 2019

(54) METHOD AND DEVICE FOR OPERATING A DISPLAY

(71) Applicant: ZF Friedrichshafen AG, Friedrichshafen (DE)

(72) Inventors: Vitali FRIBUS, Quakenbrück (DE); Andreas PEUKERT, Barnstorf (DE); Joachim SPRATTE, Osnabrueck (DE); Johannes KIRCHHOFF, Colnrade (DE)

(73) Assignee: ZF Friedrichshafen AG, Friedrichshafen (DE)

(21) Appl. No.: 16/479,541

(22) PCT Filed: Dec. 18, 2017
(86) PCT No.: PCT/EP2017/083234

§ 371 Date: Jul. 19, 2019

(30) Foreign Application Priority Data
Jan. 24, 2017 (DE) 10 2017 201 101.7

(51) Int. Cl. G09G 3/36; G09G 3/00

(52) U.S. Cl. CPC G09G 3/3688; G09G 2380/10; G09G 2330/12; G09G 3/006

(57) ABSTRACT

The present disclosure relates to a method for operating a display using a monitoring device, wherein the display contains a display matrix that has a row driver device, and a column driver device, wherein the row driver device and the column driver device each have at least one test connection connected to the monitoring device. The method includes an actuation step wherein the row driver device is actuated using row data cycles, and the column driver device is actuated using column data cycles, wherein a test signal is provided via the test connections that changes with each data cycle that is displayed. In a monitoring step, the monitoring device monitors the test signals and issues an error message if the content of at least one of the test signals remains the same for more than a predefined number of data cycles.

### RELATED APPLICATIONS

This application is a filing under 35 U.S.C. § 371 of International Patent Application PCT/EP2017/083234, filed Dec. 18, 2017, claiming priority to German Patent Application 10 2017 201 101.7, filed Jan. 24, 2017. All applications listed in this paragraph are hereby incorporated by reference in their entireties.

### TECHNICAL FIELD

The present disclosure relates to a method and a device for operating a display.

### BACKGROUND

Information can be depicted on a display in the form of graphics or text. If an error occurs when actuating the display, the information can be corrupted or no longer recognizable.

### SUMMARY

Based on this, the present disclosure provides an improved method for operating a display, an improved device that uses this method, and a corresponding computer program according to the independent claims. Advantageous embodiments can be derived from the dependent claims and the following description.

A display is refreshed cyclically. If an error occurs in a cycle, the subsequent cycle can no longer be displayed. The display “freezes.” Because the freezing is not an active process, it is only possible to detect that the display is no longer being refreshed. For this reason, an additional signal is output and monitored each time a new cycle is displayed. If the signal is received as expected, the display is operating correctly. If the signal is not received, or is corrupted, the display is not operating correctly. The signal is output directly by the row drivers and the column drivers of the display matrix so that they are displayed as close as possible to where they are actually displayed in the display actuation chain.

A method for operating a display while using a monitoring device is presented, wherein the display contains a display matrix that has at least one column driver device for actuating the display matrix by columns, and at least one row driver device for actuating the display matrix by rows, wherein the column driver device and the row driver device each have at least one test connection connected to the monitoring device, wherein the method comprises the following steps:

Actuating the column driver device using column data cycles and the row driver device using row data cycles, wherein a test signal is provided via the test connection that changes content with each data cycle that is displayed; and

Monitoring the test signals in the monitoring device, wherein an error message is generated by the monitoring device if the content of at least one of the test signals remains the same for more than a predefined number of data cycles.

A display matrix can be understood to be a group of optical elements that can be actuated individually, configured in rows and columns. An optical element can be referred to as a pixel of the display matrix. A pixel can display at least an intensity value or brightness value. The pixel can emit active light with a controllable intensity, or it can reduce the intensity of a background lighting to the specified value, by way of example. The pixel can also have a color filter. A pixel can be actuated via its rows and columns. For this, all pixels are assigned to a row and all pixels are also assigned to a column. The pixel at the intersection of the active row and the active column is actuated. A row driver device can actuate a number of rows successively. A column driver device can actuate a number of columns successively. A test connection can be an electrical connection. The test signal can be provided via the test connection, when all of the rows or columns have been actuated. A row data cycle can contain information for actuating all of the rows of the row driver devices. A column data cycle can contain information for actuating all of the columns of the column driver device. The test signal can be a signal state or numerical value, for example.

The data cycles for the column driver device and the row driver device can be generated with the test signal, wherein the test signal is forwarded from the column driver device and the row driver device to the monitoring device. By forwarding the test signal along the actuation chain of the display, the entire chain can be tested with regard to its functioning.

The content of the test signal can be determined using content of the data cycles and a processing specification. The content can be computed. This results in a low display actuation chain data volume.

The content of the test signal can be determined independently of the data cycles in the column driver device and the row driver device. By way of example, the test signal can depict the value of a counter, which counts one step further with each depicted data cycle.

The method can contain a step for executing measures when there is an error message. The error can be resolved by the measures. One measure is restarting the display, for example. When the display is restarted, the entire actuation chain is reset, and starts at known settings. Alternatively, the display can be deactivated. A deactivated display may be safer than a corrupt display in the case of information that is relevant to security.

Furthermore, a device for operating a display is presented, wherein the display contains a display matrix that has at least one column driver device for actuating the display matrix by columns, and at least one row driver device for actuating the display matrix by rows, wherein the column driver device and the row driver device each have at least one test connection that provides a test signal that changes content with each data cycle that is displayed, wherein the device comprises the following features:

a control device for actuating the column driver device using column data cycles and the row driver device using row data cycles; and

a monitoring device for monitoring the test signals, wherein the monitoring device is configured to issue an error message when the content of at least one of the test signals remains the same for more than a predefined number of data cycles.

A device can be an electrical device that processes electrical signals, e.g., sensor signals, and outputs control signals on the basis thereof. The device can have one or more interfaces, which can be hardware and/or software interfaces. With hardware interfaces, these can be part of an integrated circuit, for example, in which functions of the device are implemented. The interfaces can also be individual, integrated circuits or they can be composed at least in part of discrete components. With software interfaces, these can be in the form of a software module present on a microcontroller, for example, in addition to other software modules.

A computer program containing programming code is also advantageous, which can be stored on a machine-readable medium such as a semiconductor memory, a hard disk, or an optical memory, and used for executing any of the embodiments described above when the program is executed on a computer or a device.

### BRIEF DESCRIPTION OF THE DRAWINGS

FIG. 1 shows a display according to an exemplary embodiment of the present disclosure;

FIG. 2 shows a display with numerous row and column drivers according to an exemplary embodiment of the present disclosure; and

FIG. 3 shows a flow chart for a method for operating a display according to an exemplary embodiment of the present disclosure.

### DETAILED DESCRIPTION

In the following description of preferred exemplary embodiments of the present disclosure, identical reference symbols are used for the elements shown in the various figures with similar functions, wherein the descriptions of these elements shall not be repeated.

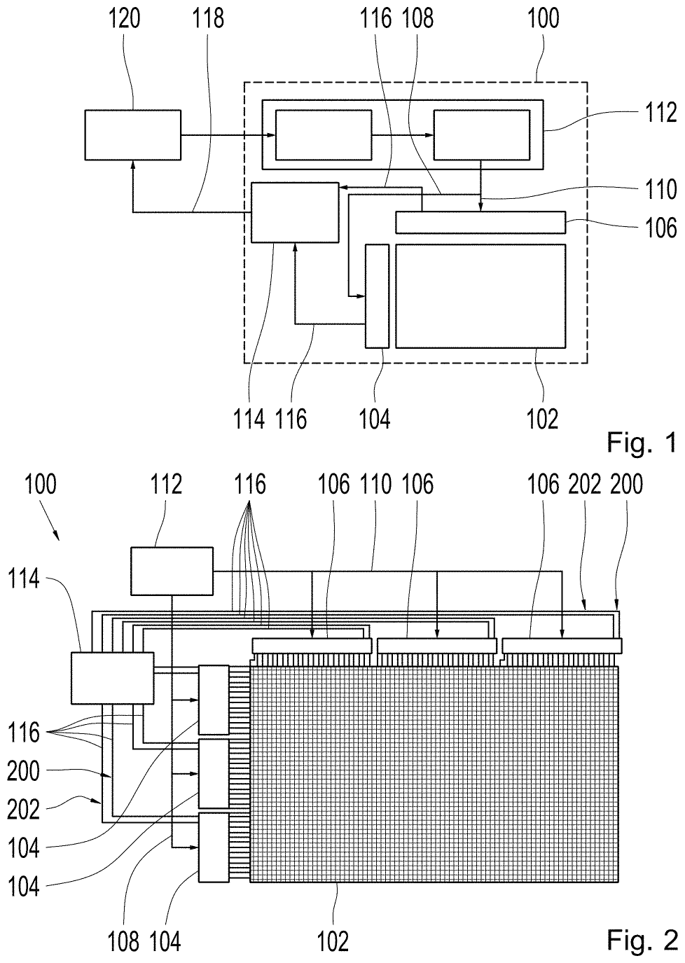

FIG. 1 shows an illustration of a display 100 according to an exemplary embodiment of the present disclosure. The display 100 has a display matrix 102 with pixels arranged in rows and columns. A pixel is located at an intersection of a row with a column. The pixel is actuated in that its row is actuated by a row driver device 104, while its column is actuated by a column driver device 106. This sets at least a brightness value for the pixel. With a color depiction, numerous pixels can be actuated in different colors as sub-pixels of a resulting image point. Different color values are set by the brightness values for the various sub-pixels. All of the image points of the display matrix 102 can be actuated in a targeted manner. To display an image on the display matrix 102, a row can be actuated, for example, while the columns are actuated successively. When the last column is actuated, the subsequent row is actuated, and the columns are actuated successively again, until all of the pixels that are to be displayed are displayed. The process can be repeated again, starting in the first row with the first pixel, in order to display a subsequent image. It is also possible to actuate a column, while the rows are actuated successively. This sequence is initiated via row data cycles 108 and column data cycles 110. Partial images can also be displayed in that a portion of the rows and/or cycles are actuated. By displaying partial images, the display matrix can appear to have a higher image frequency.

The display 100 has a control device 112 for actuating the row driver device 104 and the column driver device 114 with the data cycles 108, 110, and a monitoring device 114. The monitoring device 114 inputs test signals 116 from the row driver device 104 and the column driver device 106, which have been provided via at least one test connection 118 for the row driver device 104 and the column driver device 106. The content of the test signal 116 changes after each data cycle 108, 110 that is displayed. When a data cycle 108, 110 is not fully actuated by the row driver device 104 or the column driver device 106, the content of the corresponding test signal 116 also does not change. If no change is detected after a predefined number of data cycles 108, 110, it can be assumed that the display 100 has an error. At this point, the monitoring device issues an error message 118.

In the present case, the display 100 is connected to a microcontroller 120. When it receives the error message 118, countermeasures are taken. By way of example, the control device 112 is restarted or shut down by a command 122.

In one exemplary embodiment, the driver devices 104, 106 are configured to determine the contents of the test signals 116 themselves. By way of example, the content can be computed from the content of the data cycles 108, 110. Alternatively, the content can be determined independently of the data cycles 108, 110. By way of example, the content can change after each data cycle 108, 110 in the manner of a counter.

FIG. 2 shows an illustration of a display 100 that has numerous row driver devices 104 and column driver devices 106 according to an exemplary embodiment of the present disclosure. The display 100 corresponds substantially to the display in FIG. 1. In this case, the display matrix 102 is actuated via three row driver devices 104 and three column driver devices 106. The row and column driver devices 104, 106 are connected to the control device 112, and are actuated by it via subsidiary row data cycles 108 and subsidiary column data cycles 110. The driver devices 104, 106 are connected in this case to the monitoring device 114 via two test connections 200, 202.

In one exemplary embodiment, the two test connections 200, 202 are connected inside the driver devices 104, 106 like the outputs to the rows or the columns of the display matrix 102. By way of example, the last two outputs of the driver devices 104, 106 are used for the test connections 200, 202 to the monitoring device 114, instead of being connected to rows or columns. The data cycles 108, 110 provided by the control device 112 then contain the test signal 116 in the same form as the information for actuating the rows or columns. The test signal 116 is processed in the driver devices 104, 106 in exactly the same manner as the information for actuating the rows or columns, and is then conveyed via the test connections 200, 202 to the monitoring device 114.

By way of example, the first test connection 200 can be actuated in a first data cycle 108, 110, and the second test connection 202 can be actuated in a subsequent second data sequence 180, 110. As a result, there is a change in the content between the test connections 200, 202 with each new data cycle 108, 110 that is displayed. If there is no change after two data cycles 108, 110, for example, the error message is issued.

With digitalization in the automotive industry, displays 100 have recently been added to the interiors of automobiles. They are standard in mid-range and luxury vehicles, and form a central component of the human-machine interface. They show infotainment functions and comfort functions, as well as safety-relevant information, e.g., gear selection.

When such safety-relevant information is displayed in a vehicle, it is necessary that the display system 100 satisfies legal and customer-specific safety requirements, in order to ensure the functional safety of this electrical system.

A method is described herein for how the functionality of an LCD display 100 can be inexpensively ensured, e.g., a shift-by-wire application.

A general structure for actuating a pixel-based display 102 is shown in FIG. 1. Normally, a timing controller 112 and the gate driver 104 and source driver 106 are integrated on the display panel 100. The timing controller 112 receives the necessary information from an external microcontroller 120. The data received for displaying the corresponding image information are processed in the timing controller and forwarded in a synchronized form to the gate and source drivers 104, 106, such that the desired image is also displayed. With a higher resolution, more pixels must be actuated in order to complete a graphic. Because the gate and source drivers 104, 106 can only address a certain number of rows or columns, it is typical to use gate and source drivers 104, 106 in parallel for higher resolutions, as can be seen in FIG. 2.

When the gate and source drivers are operated unidirectionally, it is impossible to detect an error. In particular with a safety-relevant application, the serious error of a display freeze must be detected.

With the approach presented herein, it is ensured that the correct information is also sent to the pixels of the display 102.

An approach to solving the problem of monitoring data transfer to the gate and source drivers 104, 106 is illustrated in FIG. 1. In order to monitor the active data transfer, the gate and source drivers 104, 106 are expanded by one or two lines 200, 202. These lines 200, 202 lead back, e.g., to an observation controller 114. The data 116 on these lines 200, 202 have been adapted such that the content changes with each data cycle 108, 110, such that there is always a change in the content. As soon as the observation controller 114 registers the same content over at least two data cycles 108, 110, it sends this information to the central microcontroller 120, for example, such that the defective display is detected, and it is possible to react with appropriate measures.

The additional lines 200, 202 for monitoring data transfer from the gate and source drivers 104, 106 can lead to a controller 114 on the display panel 100, or they can lead out of the display 100 via an interface, in order to be monitored externally in a controller 114.

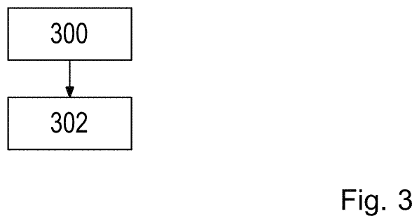

FIG. 3 shows a flow chart for a method for operating a display according to an exemplary embodiment of the present disclosure. The method can be executed using a display, for example, such as that illustrated in FIGS. 1 and 2. The method has an actuation step 300 and a monitoring step 302. In the actuation step 300, at least one row driver device and at least one column driver device of a display matrix of the display are actuated using row data cycles and column data cycles. In doing so, a content of a test signal provided via test connections of the driver devices changes with each data cycle that is displayed. The test signals are monitored in the monitoring step 302. An error message is issued when the content of at least one of the test signals remains the same for more than a predefined number of data cycles.

In other words, a method for monitoring the functionality of source drivers and gate drivers in integrated circuits in displays is presented.

The exemplary embodiments described herein and shown in the figures have only be selected by way of example. Different exemplary embodiments can be combined with one another in their entirety or with respect to individual features. Furthermore, one exemplary embodiment can be supplemented by the features of another exemplary embodiment.

Moreover, method steps according to the present disclosure can be repeated and executed in a sequence other than that described herein.

If an exemplary embodiment comprises an “and/or” conjunction between a first feature and a second feature, this can be read to mean that the exemplary embodiment according to one embodiment contains both the first and the second feature, and according to another embodiment, contains either just the first feature or just the second feature.

### REFERENCE SYMBOLS

100 display

102 display matrix

104 row driver device, driver device

106 column driver device, driver device

108 row data cycle, data cycle

110 column data cycle, data cycle

112 control device

114 monitoring device

116 test signal

118 error message

120 microcontroller

124 command

200 first test output

202 second test output

300 actuation step

302 monitoring step

1. A method for operating a display using a monitoring device, wherein the display comprises a display matrix that has at least one row driver device for actuating the display matrix by rows, and at least one column driver device for actuating the display matrix by columns, wherein the row driver device and the column driver device each have at least one test connection connected to the monitoring device, and wherein the method comprises:
actuating the row driver device using row data cycles and actuating the column driver device using column data cycles;
providing test signals via the test connections that change content with each data cycle that is displayed; and
monitoring the test signals in the monitoring device, wherein an error message is issued by the monitoring device when the content of at least one of the test signals remains the same for more than a defined number of data cycles.

2. The method according to claim 1, further comprising:
actuating the data cycles for the row driver device and the column driver device, including the test signals; and
forwarding the test signals from the row driver device and the column driver device to the monitoring device.

3. The method according to claim 1, wherein the content of the test signals is determined using content of the data cycles and a processing specification.

4. The method according to claim 1, wherein the content of the test signals is determined independently of the data cycles in the row driver device and the column driver device.

5. The method according claim 1, further comprising:
executing a countermeasure when the error message is issued.

6. The method according to claim 5, wherein executing the countermeasure further comprises restarting the display.

7. The method according to claim 5, wherein executing the countermeasure further comprises deactivating the display.

8. A device for operating a display, wherein the display comprises a display matrix that has at least one row driver device for actuating the display matrix by rows, and at least one column driver device for actuating the display matrix by columns, wherein the row driver device and the column driver device each have at least one test connection for providing a test signal that changes content with each data cycle that is displayed, and wherein the device comprises:
a control device configured to actuate the row driver device using row data cycles and to actuate the column driver device using column data cycles; and
a monitoring device configured to monitor the test signal, and to issue an error message when the content of at least one of the test signals remains the same for more than a predefined number of data cycles.

9. (canceled)

10. A machine-readable memory storing thereon a computer program that, when executed by a computing device, causes the computing device to perform a method comprising:
actuating a row driver device of a display matrix using row data cycles and actuating a column driver device of the display matrix using column data cycles;
providing test signals via test connections of the row driver device and the column driver device that change content with each data cycle that is displayed on the display matrix; and
monitoring the test signals; and
issuing an error message when the content of at least one of the test signals remains the same for more than a defined number of data cycles.

11. The machine-readable memory of claim 10, wherein the computer program causes the computing device to perform the method further comprising:
determining the content of the test signals using content of the data cycles and a processing specification.

12. The machine-readable memory of claim 10, wherein the computer program causes the computing device to perform the method further comprising:
determining the content of the test signals independently of the data cycles in the row driver device and the column driver device.

13. The machine-readable memory of claim 10, wherein the computer program causes the computing device to perform the method further comprising:
restarting the display matrix when the error message is issued.

14. The machine-readable memory of claim 10, wherein the computer program causes the computing device to perform the method further comprising:
deactivating the display matrix when the error message is issued.
